(19) United States
(12) Patent Application Publication
(10) Pub. No.: US 2010/0180350 A1
(43) Pub. Date: Jul. 15, 2010

(54) ELECTRONIC SECURITY DEVICE FOR MONITORING COMPUTER EQUIPMENT, ASSOCIATED ASSEMBLIES AND METHODS

(76) Inventor: Frederic Alexandre Glaubert, Paris (FR)

Correspondence Address: HARNESS, DICKEY & PIERCE, P.L.C., P.O. BOX 828, BLOOMFIELD HILLS, MI, 48303, US

(21) Appl. No.: 12/601,611

(22) PCT Filed: May 26, 2008
(86) PCT No.: PCT/EP2008/056430

§ 371 Date: Nov. 24, 2009

(30) Foreign Application Priority Data
May 24, 2007 (FR) 07 03690

(51) Int. Cl. G06F 21/00

(52) U.S. Cl. 726/34

(57) ABSTRACT

An electronic security device for monitoring equipment is disclosed, with each of the items of equipment being linked to a computer network by a plug and a cable at the level of a network interface, the device being arranged between an apparatus of the cabled network and the network interface of the item of computer equipment, the device comprising at the level of each linking cable between the management apparatus of the cabled network and the item of equipment to be monitored: a detection circuit able to detect on said cable, without perturbation, the presence of electrical energy originating from the item of equipment and revealing normal network activity and an isolating circuit able to be activated in the absence of such detection by the detection circuit, so as to isolate the cable in question of said cabled network, and an evaluating circuit able to be activated after the isolation performed by the isolating circuit, so as to apply to the cable a signal having a predetermined waveform, so as to detect the wave reflected and to determine on the basis of the reflected wave an abnormal condition in the circuit constituted by the cable and by the network interface of the item of equipment.

### CROSS-REFERENCE TO RELATED APPLICATIONS

This application is a National Phase Entry of International Application No. PCT/EP2008/056430, filed on May 26, 2008, which claims priority to French Application No. 07 03690, filed on May 24, 2007, both of which are incorporated by reference herein.

### BACKGROUND AND SUMMARY

The present invention concerns an electronic security device for monitoring and anti-theft protection of all types of computer equipment, and in particular, portable and fixed computers connected to the plugs of a local or other computer network.

The protection of the computer and micro-computer systems and other peripherals can traditionally be done by different types of protection, in particular:

fastening, by metal cable or other types of cable, to an anchoring point such as a table, wall, etc.

local audible alarm, in particular for portable PCs and other peripherals which can be moved, this audible alarm generally assuming the form of a small box provided with a combination lock. The alarm is attached to the carrying case, or to the laptop itself.

permanent passive tattooing; this tattoo is typically made up of a plate, generally made of metal or a composite plastic material. This plate is most often stuck obviously on the material to be protected. A unique number, combined with a barcode, is etched thereon using a laser. The identification numbers and the contact information for the owner of the material are centralized in a database, thereby dissuading thieves from reselling material which is marked in this way.

electronic marking, which consists on one hand of sticking a non-removable active electronic identifier on the material to be protected, and on the other hand of equipping all perimeter exits from the building where the material is located with detecting beacons. Thus, any identifier detected in a zone monitored by beacons will automatically trigger an alarm in a central monitoring station.

tracking, which is based on its imperceptibility and therefore on complete discretion. This method uses a program installed on the equipment to be protected in order to serve as a control device. In the event the material is stolen, one need only alert the monitoring station, which will then locate the stolen material using the control device as soon as the thief or recipient connects the equipment to the Internet.

devices like that described in patent FR-A-2770013, which is based on the addition of a dedicated case on the equipment to be monitored. To do this, it exploits a pair of conductors not used in networks using the 10BaseT or 100BaseT standards to connect it to its management case.

The drawbacks of the abovementioned protection systems are essentially the following:

for fastening by cable: each computer or item of equipment must be equipped with a key-operated anti-theft plug or a padlock, in order to be attached and therefore protected. This system therefore lacks flexibility for nomadic (portable) stations and also requires the management of the anti-theft keys; it also makes it impossible to set time rights concerning movement authorizations. Moreover, the addition of an anti-theft device with a cable greatly harms the estheticism of the protected equipment, and even their use.

for local audible alarms: other than an obvious lack of estheticism, there is a risk of inopportune triggering of the alarm, and therefore of the effectiveness and reliability of the system. Furthermore, the reduced autonomy of the alarms is a major risk for the reliability and effectiveness of the device. Also, as with cable protection, the possibility of setting time rights for movement authorizations is lacking.

for permanent tattooing: this is unsuited to the resale or leasing of computer fleets to large companies. Moreover, it is ineffective against thefts for industrial espionage and therefore in no way dissuades that kind of theft.

for tracking: its effectiveness is limited on organized trafficking. It only protects the computers and requires that the stolen apparatus be connected to the Internet in order to be located. Moreover, the system can be easily gotten around or neutralized by low-level formatting or by replacing the hard drive.

for active marking: this system requires the obligation to protect all perimeter access points, thereby leading to a very high cost for this protection. It also requires pulling numerous cables, as well as the esthetic integration of the detectors. Moreover, the lifetime of the batteries (which are not replaceable) of the identifiers limits their effectiveness to two years. Furthermore, since the system is sensitive to wireless and electromagnetic environments, it cannot be used everywhere. Likewise, there is a possibility of destroying or concealing the identifiers. Lastly, given that this protection system only detects when the perimeter is crossed, it leaves very little time to react to a theft, unless the business uses on-site watchmen present at all exits.

For the type of device described in FR-A-2770013: this assumes fixing a non-removable passive identifier on each item of equipment to be protected. And above all it requires a minimum distance to be respected between the protected material and the detection case, which can thus cause false alarms if this distance is not respected. Moreover, given that it requires a free pair of conductors, it is not applicable in that state for monitoring on Gigabit-type networks, but rather only for standard 10BaseT and 100BaseT networks. Lastly, this procedure requires a specialized operation on all of the equipment to be monitored. This is therefore a major obstacle to developing this system for large sites.

The object of the invention is to ensure monitoring, preferably ongoing and in real-time, of the equipment (portable or fixed computers; but also, all types of equipment located close to a local network plug), powered on or off, directly connected to the plugs of a local computer network or other types of networks, and advantageously also to detect any anomaly at the very source of the event. The invention thus aims to effectively exploit the existing cables of the computer network, in order to monitor the presence or absence of items of equipment, by grouping together the entire monitoring device in a set of cases, located in the computer patch bay or site. Non-network equipment may also be monitored and protected by the instant invention, but in order to do this it is necessary to add a specific passive network cable, provided with a magnetic protection contact or other devices serving the same purpose. The monitoring principle of the present invention does not rest on a pair of unused wires of the network cabling. It is therefore completely adapted to all types of networks, 10BaseT, 100BaseT and Gigabit Ethernet.

More particularly, the electronic security device for monitoring computer equipment according to the invention (each of the items of equipment being connected to a computer network by a plug and a cable at the level of a network interface) is arranged between a cabled network apparatus and the network interface of the item of computer equipment, and comprises, at the level of each linking cable between the management apparatus of the cabled network and the item of equipment to be monitored:
a detection circuit able to detect on said cable, without perturbation, the presence of electrical energy originating from the item of equipment and revealing normal network activity, and
an isolating circuit able to be activated in the absence of such detection by the detection circuit, so as to isolate the cable in question of said cabled network, and
an evaluating circuit able to be activated after the isolation performed by the isolating circuit, so as to apply a signal having a predetermined waveform to the cable, so as to detect the wave reflected and to determine, on the basis of the reflected wave, an abnormal condition in the circuit constituted by the cable and by the network interface of the item of equipment.

Advantageously, but optionally, the invention comprises at least one of the following characteristics:
at least one of the evaluating circuit, the isolating circuit and the detection circuit is situated upstream from an isolating transformer in order not to generate any electrical perturbation in the cable;
the device comprises a circuit able to detect the signals circulating on the cable and to determine from the detected signals at least one of the following pieces of information: the MAC address of the network interface, the IP address of the network interface, a username corresponding to the user of the item of computer equipment, as well as the physical port of the device on which the item of computer equipment is connected,
the device comprises a communication interface with a physical access control system of a building, in order to determine the geographical position of a user.

The invention also concerns a security assembly for monitoring items of computer equipment, comprising an electronic security device according to the invention characterized in that it also comprises a communication interface at the level of the item of computer equipment, able to communicate with the device through the cabled network. Advantageously but optionally, the invention comprises at least one of the following characteristics:
the communication interface is able to request authorization to disconnect the item of computer equipment and/or authorization to open a session for a user on the item of computer equipment,
the assembly also comprises a warning module, placed between the device and an item of computer equipment, comprising an audible and/or visual device, controlled by the security device through the network cable,
the security device is able to generate a random code from at least one of the following pieces of data: MAC address, IP address, physical port of the device on which the item of computer equipment is connected, a username for the user of the item of equipment and dynamic data, said code then being shared with the communication interface of the item of computer equipment,
the communication interface is able to automatically lock the item of
computer equipment and/or force the blanking of the item of computer equipment.

The invention also concerns a method for monitoring items of computer equipment, with a device or a security assembly according to the invention, the device (or the assembly) being arranged between an apparatus of a cabled network and an item of computer equipment to be monitored, characterized in that the method comprises the following steps:
detecting, on the cable connecting the item of computer equipment and the device, without perturbation, the presence of electrical energy originating from the item of computer equipment and revealing normal network activity,
if no signal is detected, isolating the cable from the network,
then applying a signal having a predetermined waveform to the cable,
detecting the reflected wave, and
determining, from the reflected wave, an abnormal condition in the circuit constituted by the cable and by the network interface of the item of equipment.

Advantageously but optionally, the invention comprises at least one of the following characteristics:
the method also comprises the following steps:
   detecting the signals on the cable and determining from the detected signals at least one of the following pieces of information: MAC address, IP address, username of the user of the item of computer equipment, physical port of the device on which the item of computer equipment is connected and geographical position of the user.
   determining, from the above piece(s) of information, whether the item of equipment is authorized to connect on the network and/or if the user is authorized to use said item of computer equipment,
   depending on the result of the preceding step, authorizing or limiting the network connection of the item of computer equipment and/or opening of a session for the user,
the method also comprises the following steps:
   creating a random code from at least one of the following pieces of information: username, IP address, MAC address, physical port number, dynamic data,
   sharing the random code with the communication interface of the item of computer equipment, with the aim of later comparing the code of the interface with the code of the device in order to detect a decoy attempt,
the method also comprises the following step:
   determining whether the circuit constituted by the cable and the network interface of the item of equipment is open and whether the item of computer equipment is disconnected without prior disconnect authorization, and
   if the answer is yes, triggering an alarm,
the step for triggering an alarm is done by sending the warning module a trigger order for the audible and/or visual device.

### BRIEF DESCRIPTION OF DRAWINGS

Other aspects, aims and advantages of the present invention will better emerge from reading the following detailed description of preferred embodiments thereof, provided as a non-limiting example and done in reference to the appended drawings, in which:

FIG. 1 shows the electronic diagram of one possible embodiment of the invention;

FIG. 2 shows a complete example of the device of the invention;

FIG. 3 shows the electronic diagram of the invention of another possible embodiment of the invention;

FIG. 3a is a simplified diagram of an evaluation circuit according to another possible embodiment of the invention;

FIGS. 4a to 4c are graphs illustrating the waveforms of the signal sent by the evaluation circuit;

FIG. 5 is a simplified diagram of one possible embodiment of a security assembly according to the invention; and

FIGS. 6a to 6d are schematic diagrams illustrating a method for monitoring items of computer equipment according to one possible embodiment of the invention.

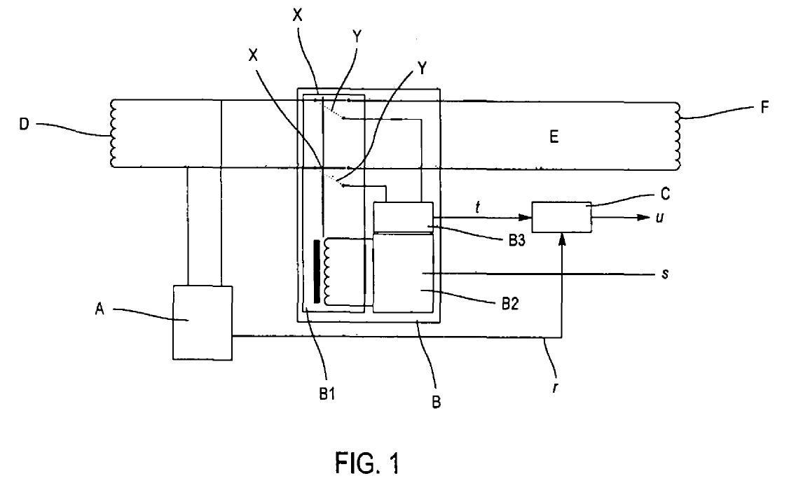

### DETAILED DESCRIPTION

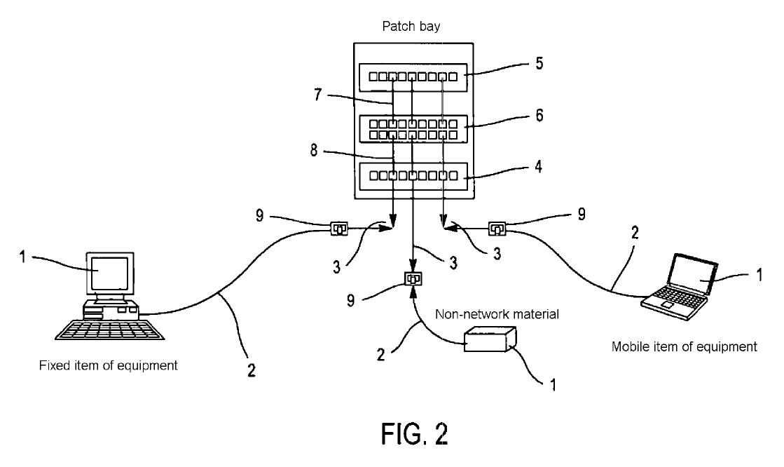

In reference first to FIG. 2, an item of computer equipment 1 (laptop or desktop computer) is connected to one of the plugs 9 of a computer network via a linking cable 2. A fixed cable 3 connects this wall plug 9 to a computer patch bay, which is found in an equipment room. Inside the patch bay are found the ends of the fixed cables 7 and 8, brought together on terminals 4 as well as the data switchers 5. An electronic monitoring case 6 houses an electronic device 10 according to the present invention. In the example of FIG. 2, one or several electronic cases 6 can be located in the patch bay or the patch site.

In the case of monitoring of an item of network equipment, each electronic monitoring device 10 is connected to the switcher 5 by a patch cable 7, and to the end of a fixed cable by a linking cable 8. In the case of monitoring of a non-network item of equipment, each electronic device 10 is simply connected to the end of a fixed cable by a linking cable 8. The monitoring device is based on an electronic circuit made up of:
1) a circuit A for detecting any network activity of the item of equipment to be monitored,
2) a measuring and isolating circuit B, which measures the electrical continuity of the circuit constituted by the assembly of the network cabling plus network interface of the item of equipment being monitored. This circuit also serves to isolate the item of equipment being monitored.
3) a decision logic circuit C of the art connected to or disconnected from the item of equipment being monitored.

The detection circuit A is connected on the pair of rising wires E of the network cable in the case of a 10BaseT, 100BaseT or Gigabit type network. Thus connected, it continuously measures the various electrical signals emitted by the network interface D of the item of equipment being monitored. The detection circuit A issues a signal r of logic level 1 if a network activity originating from the item of equipment is detected, or logic level 0 if no network activity is detected.

When the item of equipment 1 to be protected and monitored, connected to the network, is powered on, its network interface D is activated. This activity is constant once the item of equipment to be protected or monitored is powered on and continues until it is powered off. The network interface activity translates to the emission of electrical signals, at close intervals. This interval between the electrical signals is never greater than a value T imposed by the 10BaseT, 100BaseT and Gigabit standards.

The detection circuit A serves to measure the amplitude of the signals emitted by the network interface as well as the time interval separating two consecutive signals of significant amplitude. It is when electrical signals of significant amplitudes are emitted at intervals sufficiently close together by the network interface D of the item of equipment that a signal r of logic level 1 is issued, in order to signify that the equipment has normal network activity. On the contrary, when no electrical signal of significant amplitude is emitted by the network interface D, or when signals appear abnormally or erratically, then a signal r of logic level 0 is issued, to signify that the item of equipment has no network activity or is disconnected.

One will note that the detection circuit A is imperceptible or transparent to the traffic of rising data, as it has a high impedance, so as not to disrupt the signal emitted by the network interface D of the item of equipment. The measuring and isolating circuit B can be found on the same pair of rising wires as the circuit A or on a pair of descending wires, of the network cable. This alternative will then introduce two distinct variations of the electronic device.

The measuring and isolating circuit B comprises a relay B1, a control circuit B2 and a measuring circuit B3. The measuring function of the circuit B can be activated or not, depending on the value of the logic signal r issued by the detection circuit A. More specifically, this measuring function is activated when the circuit A issues a signal r of level 0, i.e. when no network activity originating from the item of equipment being monitored is detected, and not activated in the contrary case.

When the measuring function of the circuit B is activated, it issues a signal t of logic level 1 if the circuit constituted by the assembly of the network cabling, designated by E, and the network interface D of the item of equipment being monitored is closed, i.e. when the interface of the item of equipment being monitored is connected to the network. Likewise, the measuring function issues a signal t of logic level 0 if the circuit constituted by the network cabling E and network interface D assembly is open. The isolation of the item of equipment being monitored is controlled by a logic signal s. When this logic signal s is at logic level 1, this means that the item of equipment being monitored is isolated from the local computer network.

The relay B1 is in two positions x or y. In its position x, the network interface D of the item of equipment is in direct contact with the network interface of the network switcher, noted F. In this position, the network signal passes from one interface to the other without alteration. The electronic device remains imperceptible to the local network.

In the position y, the network interface D of the item of equipment is isolated from the network interface F of the switcher, but remains directly connected to the measuring circuit B3. When the logic signal s of the isolation command is at 0, the relay B1 is in position x which allows the free transmission of the network signal of the equipment with the switcher. When the measuring function of the device is active, and the relay B1 is in the position y, the measuring circuit B3 can then measure the electrical continuity of the circuit of the network interface D of the item of equipment being monitored.

In this example, the measurement of electrical continuity with the circuit B3 is done using a very low intensity direct-current generator (typically in the vicinity of 1 mA). It is when this current circulates normally through the loop constituted by the circuit of the network interface D of the item of equipment that the circuit issues a level 1 logic t, signifying the presence of the interface D. If, on the other hand, the current cannot circulate, the circuit issues a signal t of logic level 0, signifying the absence of the network interface D.

We have seen that the measuring function of the device was activated or not depending on the state of the logic signal r. The device also comprises a decision circuit C which performs an OR logic between the signals r and t and the output of which is noted u. As a result, this circuit releases a level 1 signal u when the item of equipment being monitored is connected to the network, and level 0 in the contrary case.

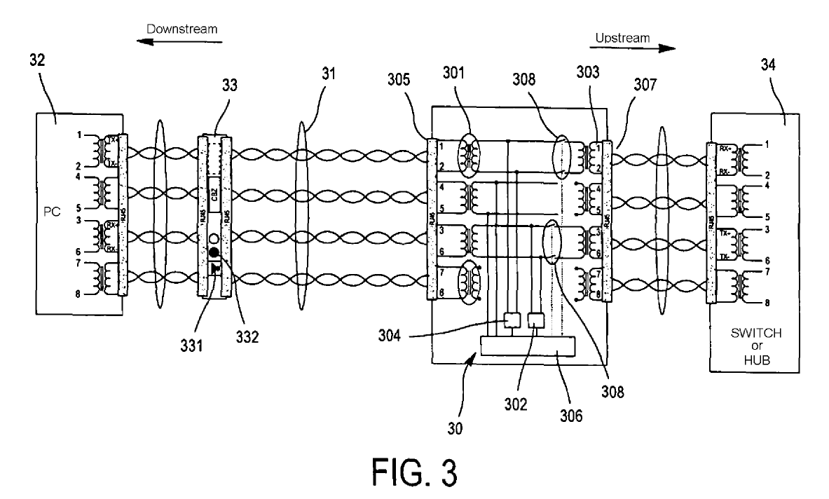

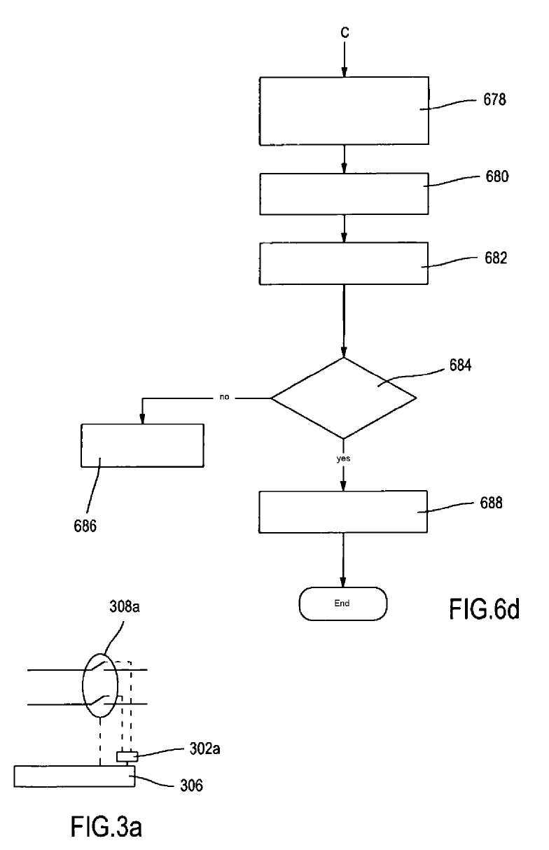

In reference now to FIG. 3, we will describe another embodiment of the invention. One will note here that the reference signs are established using a different nomenclature. The security device 30 is placed between an assembly of computer equipment 32 and a management system of the cabled network 34. The management system of the cabled network 34 is preferably a switch or a hub. Such a management system for a cabled network is known from the prior art and will not be described in more detail here.

Each item of computer equipment 32 is connected via the cabled network on a physical port 305 of the security device 30, the security device 30 also comprising output ports 307 connected to the management system of the cabled network 34. The security device 30 is in particular able to serve as a bridge between the physical input ports 305 and the output ports 307. Advantageously, it is provided that the device comprises a port dedicated to connection to the network, thereby enabling it to communicate via the network with the assembly of machines connected on the network.

The terms “connected”, “connection” or “disconnection” correspond here to the physical connection (generally wired) which exists between two items of equipment (connected by a cable). Thus the terms “connect”/“disconnect” correspond to the action of establishing or breaking the wired physical connection between two items of equipment. The term “downstream” here refers to the end of the cabled network located at the level of the network interface of the item of computer equipment 32 and “upstream” to the end of the cabled network located at the level of the management system of the cabled network 34.

The device also comprises a detection circuit 304 able to detect on the cable 31, connecting an item of computer equipment 32 and the security device 30, without perturbation, the presence of electrical energy (for example in the form of exchanged signals) originating from the item of equipment and revealing normal network activity. These signals are for example the usual signals exchanged between a network interface of an item of computer equipment and a network management system (TCP, UDP, . . . ). The detection circuit 304 also makes it possible to simply detect the presence of electrical energy. Thus such a detection can be done on all of the pairs of a cable and not only on the pairs designed to exchange signals.

The device also comprises an isolating circuit 308 to isolate the cable in question from said cabled network. Thus once the item of computer equipment is isolated, the latter no longer communicates with the network management system 34 (because the security device no longer serves as a bridge between the input ports 305 and the outlet ports 307). The isolating circuit 308 preferably comprises controlled relays 308 situated on one or several pairs of the cable. Thus, in order to isolate the item of equipment, the relay(s) open(s) the circuit formed by each pair of the cable. It should be noted that the relay(s) is/are located on the two wires which form the pair thereby allowing complete isolation.

The device comprises an evaluating circuit 302 able to send an impulse in the cable in the downstream direction, then to measure the wave reflected by the cable and determine from the wave whether the circuit constituted by the cable and by the network interface of the item of equipment is closed, open, in short circuit, or if the impedance of the circuit was modified. The circuit also allows the localization of any anomalies (short circuit, outage in the line, line opening, modification of the impedance) on the cable by determining, from said measurement, the length of cable between the anomaly and the evaluating circuit 302. Thus an opening present on the line can be evaluated as being a simple disconnection if it is situated at the level of the connection plug or a flaw in the circuit formed by the cable if the opening is situated somewhere other than the wall plug. Of course, it is provided to have a database containing all of the cable lengths separating the device from the connection plugs in order to be able to compare the measurement of the length of the anomaly with the length of cable up to the plug and to thereby determine whether it is a simple disconnection or an electrical flaw. It should be noted that the device comprises, during its connection (and before the connection of the items of computer equipment), a self-calibration method on all of its cables connected on its ports making it possible to determine the length of each cable separating the device from the connection plugs. In reference to FIG. 3a and according to one possible embodiment of the invention, the evaluating circuit 302a is arranged upstream from the isolating circuit 308a, such that the isolating circuit 308, by isolating the item of computer equipment, switches the evaluating circuit 302a on the circuit formed by the item of computer equipment and the downstream cable thereby avoiding the evaluating circuit 302a electrically interfering with the network when the item of equipment is not isolated.

The operation of the evaluating circuit 302 is based on the properties of electromagnetic wave propagation guided by two conductors (in our case a pair of the cable 31). The operation of the evaluating circuit 302 comprises the following steps:
emitting a signal having a predetermined waveform, such as a train of rectangular impulses,
analyzing the reflected waves,
evaluating whether the line is closed, open or in short circuit, or if its impedance has been modified,
in case of short circuit or opening of the circuit, evaluating the location of the opening or of the short circuit by expressing the cable length, between the evaluating circuit 302 and the opening or the short circuit, for example in order to determine whether it involves a simple disconnection or an electrical anomaly.

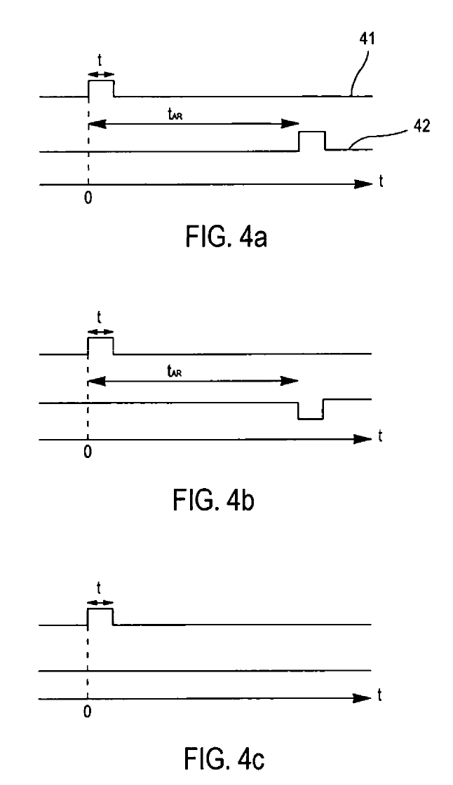

In reference to FIGS. 4a to 4c, the evaluating circuit 302 generates an impulse of width τ at t=0 on a line of length l. The evaluating circuit also comprises a device able to measure the reflected wave in amplitude and the time t_{AR} having passed since the beginning of transmission. In reference to FIG. 4a, where the graph 41 shows the impulse emitted on a temporal axis and the graph 42 shows the return impulse along the same temporal axis, if the impulse is returned like it was sent toward the evaluating circuit, its round trip lasting tAR as illustrated, this means that the line is open. Thus at t=0, the impulse of width τ is sent and it returns like it was sent toward the evaluating circuit making it possible to determine that the line is open.

If the impulse is returned inverted toward the evaluating circuit, its round trip lasting t_{AR} as illustrated in FIG. 4b, this means that the line is in short circuit. If no return impulse is sent back, as illustrated in FIG. 4c, this means that the line is closed with a charge. We define “closed” as the fact that the line is closed with a charge whereof the charge is non-null (contrary to a short circuit). Knowing t_{AR} makes it possible to know the length l of cable between the aforementioned event (short circuit or open line) from the following formula:

$$L = u \cdot ( {t}_{AR} / 2 ) with u = \frac{1}{\sqrt{LC}} ,$$

L and C being the linear coil and linear capacity of the cable, respectively.

L and C are data which can be obtained at the evaluating circuit for example in a configuration phase of the device. In the case of an Ethernet cable (comprising polypropylene), u is approximately equal to 1.9×10⁸ m/s. It should be noted that in the case of a line with losses (the linear resistance of the cable being non-negligible), the results remain identical but the impulses emitted and reflected are weakened and deformed according to the length of the line. In open circuit, even with a line without loss, the reflected impulse has an amplitude a little weaker than the transmitted impulse because in this case the line behaves like an antenna with radiation of electromagnetic energy to the outside. This evaluating circuit makes it possible to perform the evaluations previously described on any type of cable, not just network cables. It should be noted that the evaluating circuit can also detect any modification of the impedance of the circuit, thereby making it possible to detect a parallel connection of a second item of computer equipment on the same cable in the case of a decoy attempt.

Returning to FIG. 3, the security device also comprises a control unit 306 designed to control and coordinate the detection 304, isolating 308 and evaluating 302 circuits. Preferably, all of these circuits are situated between a downstream transformer 301 and an upstream transformer 303 with the aim of not generating any electrical perturbation in the downstream and upstream cables, preserving the galvanic isolation and not unbalancing the line. Optionally, the detection 304 and evaluating 302 circuits are arranged on different pairs of the network cable in order to avoid any interference between the operation of the two circuits. Each pair comprising the detection circuit 304 and/or the evaluating circuit 302 comprises an isolating circuit 308.

According to one possible embodiment of the invention, a warning module 33 is arranged on the downstream cable between the security device 30 and the item of computer equipment 32. Advantageously, this warning module 33 comprises an audible indicator 331 and a visual indicator 332. This module is controlled by the security device via the network cable. Preferably this warning module 33 does not comprise any local electrical power source and uses power delivered via the Network cable (for example using the “Power Over Ethernet” technology—IEEE standard 802.3af). One preferably uses pairs not used for the power and the control of the warning module 33.

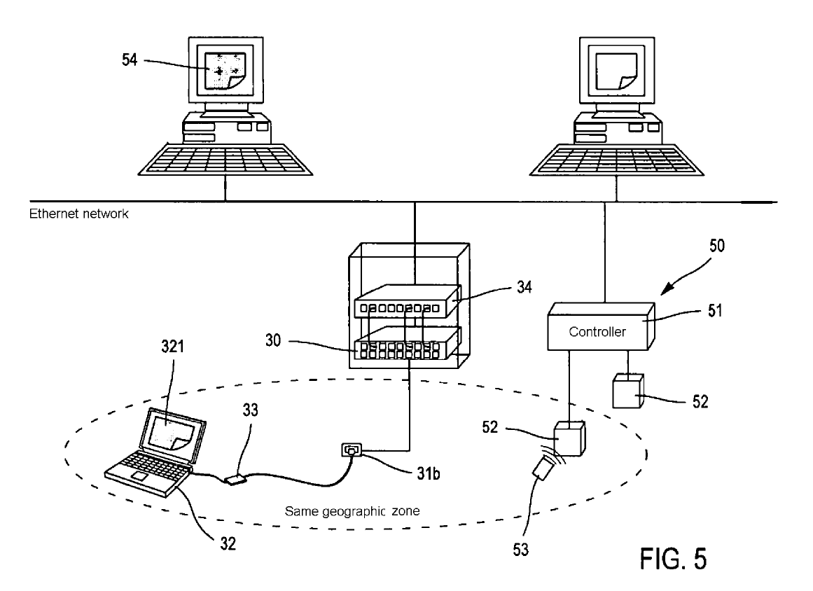

This module is designed to be arranged permanently at the downstream network cable, the user of the computer equipment then directly connecting/disconnecting his equipment on the/of the warning module 33. In reference to FIG. 5, the warning module 33 can be arranged downstream from a wall plug of the cabled network (the plug being connected to the security device 30).

Advantageously, the security device 30 is connected to a physical access control system 50. The physical access control system 50 is a control system for entry and exit requests and authorizations, for example within a building or an industrial site. Generally the building is divided into several geographical zones, each of the regions having specific access rights.

Each user (for example an employee in a building) has an access request device which allows him to request permission to access and/or leave a geographical zone from the physical access control system 50. The latter system verifies the compatibility of the user's rights and the geographical zone requested in order to make the decision whether or not to allow the user to enter/exit said zone. Physically, the physical access control is for example ensured by doors with automatic opening and closing or gates. The access request device 53 of the user is preferably an access card using RF technology (for example RFID or NFC technology). The request is therefore established with the physical access control system 50 via a request terminal 52, for example a RFID or NEC antenna terminal. The security device 30 communicates with the control unit 51 of the physical access control system 50 using the cabled network, which avoids the need to have other communication interfaces for the device. Thus the device in communication with the physical access control system 50 is able to know the geographical position of a user.

Advantageously, the security device 30 also comprises means for reading frames passing through it in order to determine information concerning the connection of the network information equipment, for example the MAC address and IP address or other information concerning the user of the item of computer equipment such as a username. This username (generally accompanied by a password) is used in order to identify the user on the item of computer equipment. This allows the user to request that a session be opened on the item of computer equipment, but also makes it possible to be able to identify oneself to the computer network, possibly with the aim of updating elements of the item of computer equipment corresponding to the user (for example access to personalized storage areas).

Advantageously, the device comprises storage spaces for the geographical location of wall plugs of the network corresponding to each physical input port of the security device. Advantageously, certain wall plugs of the network corresponding to certain input ports of the device are dedicated to a so-called “anonymous” use of the network; i.e. they are dedicated to the connection of a non-inventoried item of computer equipment to the network (for example an item of computer equipment belonging to a “visitor”). Advantageously, administrative access 54, for example using a computer connected to the network, is provided so that an authorized user can administer and configure the security device 30. It is provided in particular that the user can have access to the log including, for example, connection requests, access attempts, alerts, . . . .

A real-time alert can also be triggered at the level of the administrator access 54 in order to warn the administrator of a specific event. In general, an “alert” or “alarm” refers to a warning made to the user or administrator. This alert can assume the form of an interface triggered at the level of the administrator access 54 intended for the administrator, but also the activation of the audible and/or visual device of the warning module 33 with the aim of warning the user. These alarms can be of different priorities (for example low, medium and high) depending on the seriousness of the event. It can be provided that these alerts can be deactivated by the administrator via the administrator access 54. If an item of computer equipment being monitored is disconnected without prior authorization of the user, then an alert is activated (for example at the level of the warning module 33) which thereby alerts one of any attempt to steal the item of computer equipment.

Advantageously, it is provided that the item of computer equipment also comprises a communication interface 321. This interface can be a device added to the item of computer equipment (for example an improved network interface device) or an element intrinsic to the equipment, for example in the form of a program executable by the processing unit of the item of computer equipment. This communication interface is able to communicate with the device via the cabled network even when the item of computer equipment is isolated from the network by the device. The interface allows the user to make requests of the device such as requests to open a session or disconnect the item of computer equipment. Optionally, the interface also makes it possible to warn the user that an alarm has been triggered or that a warning has been transmitted by the device. Advantageously, the communication interface is able to automatically lock the item of computer equipment and/or force the blanking of the item of computer equipment.

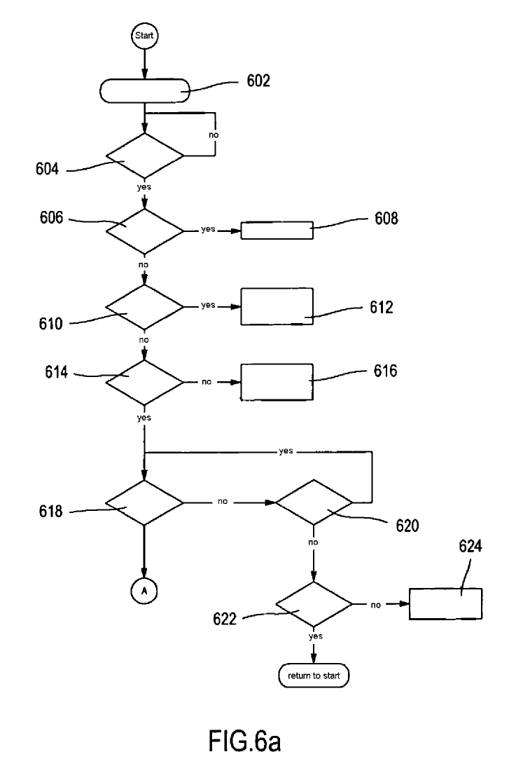

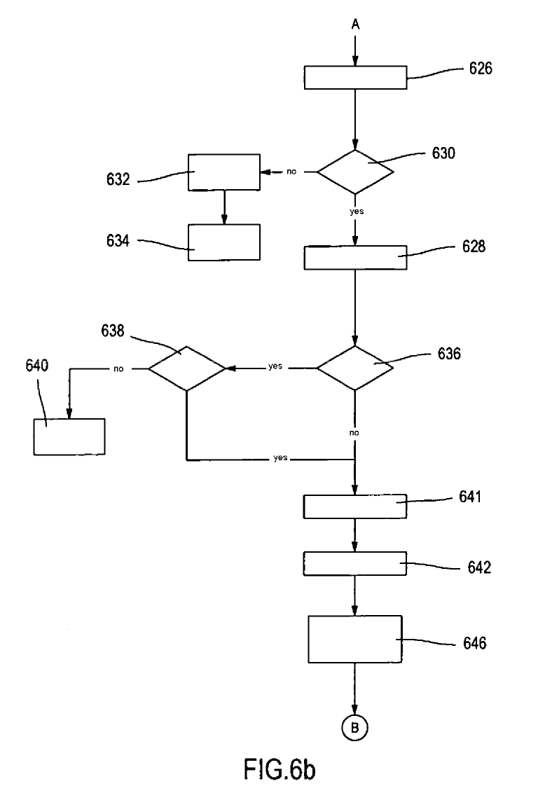

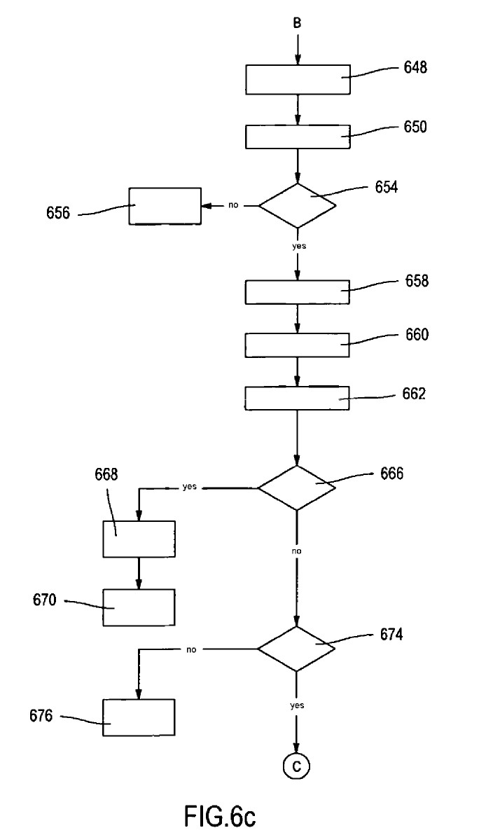

In reference to FIGS. 6a to 6d, a method for connecting an item of network equipment is made up of the following steps: A physical connection (step 602) of an item of computer equipment is done. This connection is done either at the level of a wall plug of the network or at the level of a warning module 33 (see FIG. 5).

The security device then detects the presence of the item of equipment and possibly the absence of anomalies on the cable using the evaluating circuit (step 604). It should be noted that by default the isolating circuit isolates the item of computer equipment from the network during its connection until the device authorizes its connection to the network. If the security device indeed detects the presence of the item of equipment (closed circuit) without anomaly, it proceeds with a verification of the anonymity of the input port to which the item of equipment is connected (step 606). If the item of equipment is connected on an anonymous port, then it is automatically put under monitoring with or without access to the computer network depending on the establishment's security policy (step 608). It is noted that the computer equipment of the “anonymous” type can also be a non-network item of equipment such as a video projector or a computer monitor. In this case, the connection cable will not be a network cable with a specific end fixed on the protected equipment.

If the port is not anonymous, the device then verifies whether the port is not locked (step 610). In fact, the port can have been locked during an earlier procedure for security reasons, thereby prohibiting connection to that port; it is provided to be able to lock the ports at the level of the administrator access. An alarm (for example, a high priority alarm) can be triggered until the item of computer equipment is disconnected. Such an alarm can for example be dismissed at the level of the administrator access (step 612).

If the port is not locked, the device then verifies that the time is authorized (step 614). In fact, it is provided for an alarm to sound if a connection is done during certain configurable time periods, for example during the night. If the time is not authorized, an alarm is triggered (step 616), for example with a medium priority level.

If the time is authorized, then the device verifies that the item of equipment is indeed powered on using its detection circuit by verifying in particular the presence of electrical energy in the cable (step 618). If the item of equipment is not powered on, then the device verifies whether the equipment is still connected using its evaluating circuit (step 620). If the item of equipment is still connected, the device loops on the preceding step 618.

If the item of equipment is no longer connected, the device verifies whether the equipment was indeed disconnected after an authorized procedure (step 622). If this is not the case, an alarm, for example a high priority alarm, is triggered (step 624). If the equipment is powered on, the device establishes a connection with the network interface of the network equipment in order to recover the MAC address of the network interface (step 626). At this stage, the item of equipment is still isolated from the network.

The device then makes a connection between the recovered MAC address and the number of the physical port on which the item of equipment is connected (step 628). The device then verifies that the MAC address is authorized to connect, by verifying for example that it is not part of a configurable blacklist (step 630). If the MAC address is not authorized to connect, the item of equipment remains isolated from the network and an alarm, for example a high priority alarm, is engaged (step 632). If the item of equipment comprises a communication interface with the device, then the device communicates with the interface so that the latter forces the blanking of the PC (step 634).

The device then verifies that the port is not exclusive, i.e. reserved for a single MAC address (step 636). If the port is exclusive, the device then verifies that the MAC address indeed corresponds to this exclusivity (step 638); if this is not the case, an alarm, for example a low priority alarm, is engaged (step 640). If the MAC address indeed corresponds to this exclusivity or if the port is not exclusive, the device is then connected to the network (step 641). The item of equipment then establishes a dialogue with the network's management system in order to establish an IP address (DHCP or fixed address). The device detects (or “listens to”) this address in the exchanged frames (step 642). Once the IP address is detected, the device establishes a first twinning between the MAC address, the IP address and the port number (step 646).

The device initiates a dialogue with the communication interface in order to open a secured channel (step 648). The communication interface then opens a secured channel, for example of the SSL type, with the device. The security interface then verifies that the certificate corresponds to a valid certificate 654. If the certificate is not valid, then the item of equipment is isolated from the network and an alarm, for example a high priority alarm, is engaged.

If the certificate is valid, the communication interface requests identification from the user. Preferably, the user enters a username and a password in order to perform this identification (step 658). The interface then times the session opening while waiting for authorization from the device (step 660). The communication interface sends the identification information to the device for verification (step 662) from the received corresponding frames.

The device verifies whether the user is authorized to use the item of computer equipment, by verifying for example that the user is not part of a user blacklist (step 666). If the user is not authorized, an alarm, for example a high priority alarm, is triggered (step 668). The device isolates the item of equipment and communicates with the communication interface so that the latter forces the blanking of the item of computer equipment (step 670).

If the user is authorized to use the item of computer equipment, the device then verifies that the geographical location of the user (by communicating, for example, with the physical access control system) is the same as that of the computer equipment (by comparing the location of the user with that of the wall plug in which the item of equipment is connected) (step 674). If the location is not the same, an alarm (for example a high priority alarm) is engaged, and it is provided that the user must identify himself (for example on the badge reader) in the same geographical zone as the item of computer equipment and possibly try a new identification. If the location is the same, a second twinning is done between the username, the MAC address and the IP address and the physical port number on which the item of computer equipment is connected (step 678).

The device then creates a random twinning code; for example established from the username, the MAC address and the IP address and the physical port number on which the item of computer equipment is connected and dynamic data such as the date and time of the connection; the device then shares this random twinning code with the communication interface (step 680). The device then sends the communication interface the restricted or unrestricted rights to the network's resources for the user (step 682). A verification is done in order to verify whether the user is authorized to connect on this physical port (step 684). If this is not the case, access to the network is blocked and an alarm, for example a low priority alarm, is engaged (step 686).

If the user is authorized to connect on that port, the device communicates with the communication interface so that the latter authorizes opening of the user's session. It is provided that this session opening is within the limitation of the rights granted by the device in step 682 (step 688). All of the previously described steps make it possible to detect a set of fraud attempts.

In a first case, a user tries to disconnect a first item of equipment and reconnect a second item of decoy equipment in place of the original item. A first alarm is engaged because the item of equipment was disconnected without requesting authorization. The device then determines the MAC address and/or the integrity of the random twinning code which was shared in step 680 and/or the integrity of the certificate of the secured communication between the device and the communication interface. In the case where one of these pieces of information is not identical to that established during connection of the first item of equipment, an alarm can be triggered, alerting the administrator of a decoy attempt. The advantage provided by the shared random twinning code is that, in the case where the decoy equipment is configured so as to provide the same MAC address as the first disconnected item of equipment, it cannot determine and provide the right shared random twinning code; the decoy is therefore automatically detected. In the same way, an item of computer equipment disconnected and reconnected on a decoy device detects the decoy using the shared random twinning code, which is not the same. It is then provided that the switch interface alerts the user and/or forces the blanking of the equipment.

Of course, a start-up method cannot use all of the steps previously described. In particular, if the item of computer equipment in question does not have a communication interface, the steps concerning the communications between the device and the communication interface are not implemented. It can also be provided that the warning module 33 comprises means for requesting disconnection of the equipment. These means are for example a RF device (RFID or NEC) allowing the user to use his badge in order to make a disconnection authorization request. The warning module having detected the presence of a badge (RF technology) transmits the authorization request to the device along with a username for the concerned badge. The device then verifies that the holder of the badge is indeed authorized to disconnect the equipment and, if that is the case, authorizes the disconnection of the equipment, allowing the user to disconnect the equipment without triggering the alarm.

1. An electronic security device for monitoring computer equipment, each of the items of equipment being connected to a computer network by a plug and a cable at the level of a network interface, the device being arranged between an apparatus of the cabled network and the network interface of the item of computer equipment, the device comprising at the level of each linking cable between the management apparatus of the cabled network and the equipment to be monitored:
a detection circuit able to detect on said cable, without perturbation, the presence of electrical energy originating from the equipment and revealing normal network activity, and
an isolating circuit able to be activated in the absence of such a detection by the detection circuit, in order to isolate the cable in question from the cabled network, and
an evaluating circuit able to be activated after the isolation done by the isolating circuit, to apply on the cable a signal having a predetermined waveform, in order to detect the reflected wave and in order to determine from the reflected wave an abnormal condition in the circuit constituted by the cable and by the network interface of the item of equipment.

2. The electronic security device according to claim 1 in which at least one among the evaluating circuit, the isolating circuit and the detection circuit is situated upstream from an isolating transformer in order not to generate any electrical perturbation in the cable.

3. The electronic security device according to claim 1, which comprises a circuit able to detect the signals circulating on the cable and to determine from the detected signals at least one of the following pieces of information: the MAC address of the network interface, the IP address of the network interface, a username corresponding to the user of the item of computer equipment, as well as the physical port of the device on which the item of computer equipment is connected.

4. The electronic security device according to claim 1, which comprises a communication interface with a physical access control system of a building, in order to determine the geographical position of a user.

5. A security assembly for monitoring computer equipment, comprising an electronic security device according to claim 1, wherein it also comprises a communication interface at the level of the item of computer equipment able to communication with the device through the cabled network.

6. The security assembly according to claim 5, in which the communication interface is able to request an authorization to disconnect the item of computer equipment and/or an authorization to open a session for a user on the item of computer equipment.

7. The security assembly according to claim 5, also comprising a warning module, placed between the device and an item of computer equipment, comprising an device and/or visual device, controlled by the security device through the cabled network.

8. The security assembly according to claim 5, in which the security device is able to generate a random code from at least one of the following pieces of data: MAC address, IP address, physical port of the device on which the item of computer equipment is connected, a username of the user of the item of equipment and dynamic data, said code then being shared with the communication interface of the item of computer equipment.

9. The security assembly according to claim 5, in which the communication interface is able to automatically lock the item of computer equipment and/or force the blanking of the item of computer equipment.

10. A method for monitoring computer equipment, with a security device arranged between an apparatus of a cabled network and an item of computer equipment to be monitored, wherein the method comprises the following steps:
detecting on the cable connecting the item of computer equipment and the device, without perturbation, the presence of electrical energy originating from the item of computer equipment and revealing normal network activity,
if no signal is detected, isolating the cable from the network,
then applying a signal having a predetermined waveform on the cable,
detecting the reflected wave, and
determining from the reflected wave an abnormal condition in the circuit constituted by the cable and by the network interface of the item of equipment.

11. The method according to claim 10, which also comprises the following steps:
detecting the signals on the cable and determining from the detected signals at least one of the following pieces of information: MAC address, IP address, username of the user of the item of computer equipment, physical port of the device on which the item of computer equipment is connected and geographical position of the user,
determining from the aforementioned piece(s) of information whether the item of equipment is authorized to connect on the network and/or if the user is authorized to use said item of computer equipment,
depending on the result of the preceding step, authorizing or limiting the network connection of the item of computer equipment and/or the opening of a session for the user.

12. The method according to claim 10, which also comprises the following steps:
creating a random code from at least one of the following pieces of information: username, IP address, MAC address, physical port number, dynamic data,
sharing the random code with the communication interface of the piece of computer equipment, with the aim of later comparing the code of the interface with that of the device in order to detect a decoy attempt.

13. The method according to claim 10, which also comprises the following step:
determining whether the circuit constituted by the cable and by the network interface of the item of equipment is open and whether the item of computer equipment is disconnected without prior disconnection authorization, and
if the answer is yes, triggering an alarm.

14. The method according to claim 13, in which the step for triggering an alarm is realized by sending an order to the warning module to trigger the audible and/or visual device.
